(19) United States
(12) Patent Application Publication
(10) Pub. No.: US 2014/0006632 A1
(43) Pub. Date: Jan. 2, 2014

(54) Multiplexer Load Balancer for Session Initiation Protocol Traffic

(71) Applicant: Timothy Evens, Bainbridge Island, WA (US)

(72) Inventor: Timothy Evens, Bainbridge Island, WA (US)

(73) Assignee: CISCO TECHNOLOGY, INC., San Jose, CA (US)

(21) Appl. No.: 13/539,820

(22) Filed: Jul. 2, 2012

(51) Int. Cl. G06F 15/16

(52) U.S. Cl. 709/227

(57) ABSTRACT

A SIP multiplexer load balancer is provided that load balances both incoming and outgoing SIP dialogs based on regular expression matching (including multiple subgroup matching) and multiplexes SIP messages to any of a variety of transport protocol flows. SIP messages are received from clients and servers. The SIP messages are evaluated based on regular expression matching. The SIP messages are then load balanced to one or more of a plurality of transport flows based on the evaluation.

### TECHNICAL FIELD

The present disclosure relates to managing session-based protocol traffic in a network.

### BACKGROUND

The Session Initiation Protocol (SIP) has gained widespread acceptance recently, particularly for Voice over IP (VoIP) networks. SIP is a session-based protocol in the Open Systems Interconnection (OSI) model, or an application-layer protocol in the Transport Control Protocol/Internet Protocol (TCP/IP) model, that enables the creation, management, and tear-down of SIP traffic for VoIP, as well as other messaging and media applications.

SIP load balancing scales and optimizes a SIP infrastructure by using separate, dedicated servers for SIP registration. SIP registration and SIP proxy traffic are handled in separate service groups, whose servers can be monitored with separate SIP health checks for registration or non-registration traffic.

### BRIEF DESCRIPTION OF THE DRAWINGS

FIG. 1 is a software/functional block diagram of a SIP multiplexing load balancer.

FIG. 2 is flow chart depicting a high level view of the operations of the SIP multiplexing load balancer.

FIG. 3 is a flow chart generally depicting two types of load balancing performed by the SIP multiplexing load balancer.

FIGS. 4A and 4B is a flow chart that illustrates the operations of the SIP multiplexing load balancer for an example of an Invite message sent by a SIP client or server.

FIG. 5 is a flow diagram depicting operations of the rules engine in the SIP multiplexing load balancer.

FIG. 6 is a block diagram showing how the SIP multiplexing server maintains multiplexed sessions to each SIP server instance.

FIG. 7 is a block diagram illustrating how the SIP multiplexer load balancer multiplexes and load balances flows associated with multiple calls.

FIG. 8 is a ladder diagram illustrating an example of how the SIP multiplexer load balancer handles a call initiated by a SIP client.

FIG. 9 is an example hardware block diagram of the SIP multiplexer load balancer.

### DESCRIPTION OF EXAMPLE EMBODIMENTS

### Overview

A SIP multiplexer load balancer is provided that load balances both incoming and outgoing SIP dialogs based on regular expression matching (including multiple subgroup matching) and multiplexes SIP messages to any of a variety of transport protocol flows. SIP messages are received from clients and servers. The SIP messages are evaluated based on regular expression matching. The SIP messages are then load balanced to one or more of a plurality of transport flows based on the evaluation.

### Example Embodiments

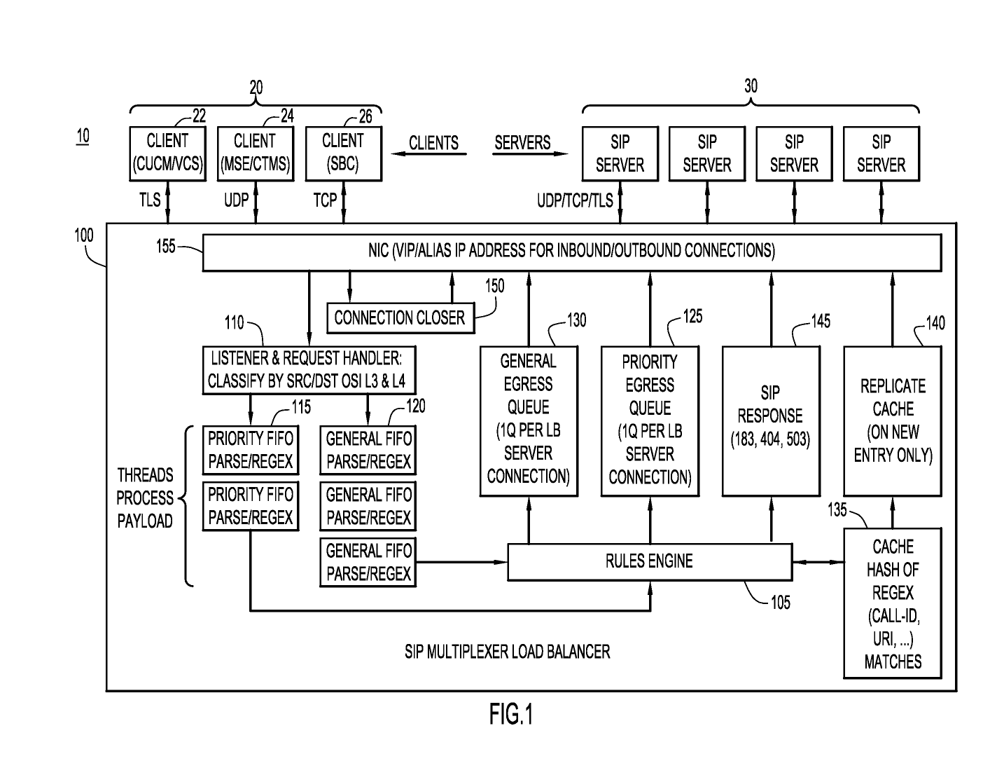

The subject matter presented herein relates to a load balancer for session exchanges, such as those in accordance with the Session Initiation Protocol (SIP). Referring first to FIG. 1, a block diagram is shown of a communication system 10 in which a SIP load balancer device 100 is provided to load balance SIP messages sent between clients 20 and SIP servers 30. Examples of clients 20 include a Cisco Unified Communications Manager/Video Communication Server (CUCM/VCS) 22, a multipoint switch/Cisco TelePresence Management Server (MSE/CTMS) 24, and a session border controller (SBC) 26. The clients 20 may use different transport protocols to communicate with SIP servers 30. For example, the VCS 22 may use the Transport Layer Security (TLS) protocol, the multipoint switch 24 may use the Universal Datagram Protocol (UDP) and the SBC 26 may use the Transport Control Protocol (TCP). The transport protocols used by the SIP servers 30 may include any of a variety of transport protocols, including TLS, UDP and TCP, and are completely independent of the transport protocols used by the clients 30.

The SIP load balancer device 100 is referred to as a SIP multiplexer load balancer (SMLB) because it load balances based on multiplexing transport connections. This enables a SIP message to be load balanced at the application level, while the transport connection can be flexible and heterogeneous. As a result, several new SIP server features are enabled that are not available with current SIP load balancers.

The SMLB 100 is a highly available SIP transport level multiplexer that load balances both incoming and outgoing SIP dialogs based on regular expression matching. Prioritization of SIP dialogs are categorized and queued to ensure proper forwarding of messages symmetrically between real servers and clients. Multiple transports connections can be inter-mixed between clients and servers.

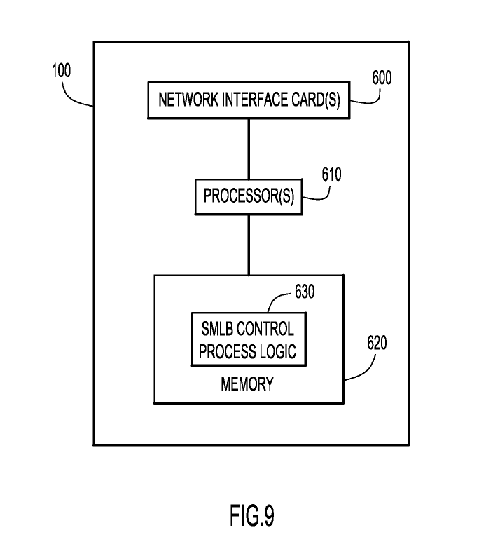

In FIG. 1, the blocks inside the SMLB 100 are functional/software blocks. An example of a hardware block diagram of the SMLB 100 is described hereinafter in connection with FIG. 9. The function blocks of the SMLB 100 include a rules engine 105, a listener and request handler 110 for each transport protocol type that is handled by the SMLB, an instance of a priority first-in first-out (FIFO) buffer 115 for any active threads, an instance of a general FIFO buffer 120 for any active threads, a priority egress queue 125, a general egress queue 130, a cache 135 and a replicate cache 140, a SIP response block 145, a connection closer block 150 and a network interface controller (NIC) layer 155.

The rules engine 105 stores user defined profiles for policy control, security and other conditions associated with evaluation of SIP messages for load balancing. The rules engine 105 evaluates information obtained from the SIP messages based on regular expression matching and in general without interpreting the SIP messages, in order to determine how to load balance the SIP messages.

The listener and request handler 110 classifies SIP messages based on source and destination at OSI Layer 3 and Layer 4. There is an instance of the listener and request handler 110 for each transport protocol supported by the SMLB 100. The listener and request handler 110 classifies the SIP messages, from the source and destination information, as being from a server or from a client. Based on the type of the SIP message, the listener and request hander 110 will direct the SIP message to either the priority FIFO 115 or general FIFO 120. The rules engine 105 will then further process the queued SIP messages in the FIFOs 115 and 120 and direct each SIP message either to the general egress queue 130 or the priority egress queue 135. Messages are then output from the queues 130 and 135 such that SIP messages from the priority egress queue 135 are given priority over SIP messages in the general egress queue 130, which is allocated for output using “best effort” processing.

AS will become more apparent from the following description, SIP messages to be sent back to a SIP server is placed into one of multiple queues (e.g., queues 130 and 135) according to the SIP message type, such that each queue has a different prioritization for output.

The SMLB 100 takes advantage of the contact addressing within SIP messages. The SMLB 100 does not modify or change any SIP/Session Description Protocol (SDP) content, which enables the SMLB 100 to support any SIP header and any SDP payload, including Secure/Multipurpose Internet Mail Extensions (S/MIME).

The SMLB 100 acts as SIP multiplexer in that it takes the UDP/TCP/TLS payload from a client connection and multiplexes it to one or more TCP/TLS server connections. The reverse of this is also achieved from the server to client. Both client and server connections are made to one or more virtual IP (VIP)/alias addresses (IPv4/IPv6) of the SMLB 100.

The rules engine 105 enables security, rate-limiting, and conditional SIP message responses based on various rules. The rules engine 105 of the SMLB 100 checks the source address of the connection and determines if the connection is from a server or client. If the SIP message on the connection is from a client, the payload is load balanced to one of the server connections. If the connection is from a configured load balanced server, the payload is multiplexed to an existing or new connection to the client based on the SIP Universal Resource Identifier (URI). The SIP response block 145 generates any needed SIP response.

Persistence and load balance selection criteria are accomplished by SIP method and a series of configurable regular expression pattern matching strings handled by the rules engine 105. The SIP method and matching regular expression subgroups (based on call ID, URI, etc.) matches are hashed to ensure that subsequent messages are forwarded/multiplexed using the same connections. These hashes are stored in the cache 135, and in some instances, replicated for storage in the replicate cache 140.

More specifically, there is a regular expression that identifies a SIP message as being a dialog, which may or may not be the same regular expressions used for the load balancing decision. The load balancing decision is more complex and it is expected that many SIP header lines and subgroup values will be used to make the load balancing selection. All regular expressions support subgroup matching. Once the load balancing decision is made, the hash of the dialog regular expression is cached, in the cache 135, so that subsequent messages follow the same path bi-directionally.

The reason two regular expressions are used is because the load balancing decision is normally done once when deciding which load balancing policy/rules to apply for a SIP message flow/dialog. Identifying a SIP message as being a dialog is simpler, and less work for the system, since SIP already contains stateful information in messages to indicate a dialog, such as the Call-ID header plus SIP methods being used.

Traditional SIP load balancers use the Call-ID only for stateful dialog identification. The SMLB 100 uses a regular expression to hash the dialog stateful information, which enables the ability to include more than just the Call-ID. This is desirable because not all SIP messages that contain a Call-ID should be load balanced in a stateful/sticky fashion, such as an OPTIONS PING SIP message. There is another regular expression that identifies a SIP message as being a dialog regardless of the regular expression used to load balance the message.

The SMLB 100 acts as a single interface load balancer in that it can run within a SIP server, in parallel to the SIP server, or multiple layer-3 hops away from the SIP server. High availability is achieved by replicating the load balancing cache 135 (to create replicate cache 140) and server selection between one or more additional redundant SMLBs (not shown in FIG. 1). TCP/TLS connections are not replicated, but the connection closer block 150 will gracefully close old connections during failover using a TCP FIN/ACK mechanism instead of sending a TCP reset (RST) packet.

The SMLB 100 is able to load balance and scale for multiple SIP servers, without having to interpret all the SIP messages. The SMLB 100 takes a received SIP message at the application layer (L5 and above), does not interpret or manipulate it, and passes it to another input/output (IO) socket (bridging sockets). In other words, the SMLB 100 can take SIP messages from one or more streams and multiplex them to one or more streams on another side without changing the SIP message or interpreting the SIP message.

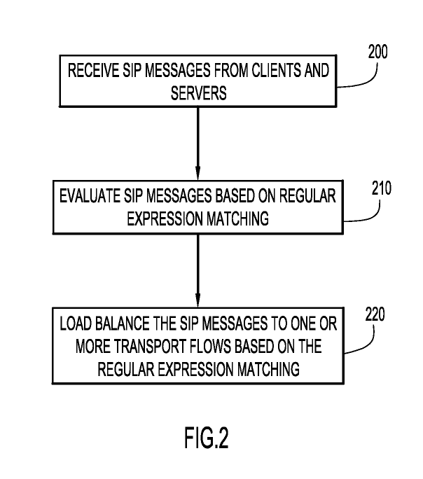

The operations of the various blocks of the SMLB 100 are described hereinafter in connection with FIGS. 2-8.

Reference is now made to FIG. 2. FIG. 2 illustrates a high level flow chart depicting of the SMLB 100. At 200, the SMLB 100 receives SIP messages from clients and servers. At 210, the SMLB 100 evaluates the SIP messages based on regular expression matching. At 220, the SMLB 100 load balances the SIP messages to one or more of a plurality of transport flows based on the outcome of the evaluation operation at 210.

A basic description of the parameters of a SIP message is now described to facilitate the understanding of the operation of the SMLB 100. SIP is a signaling protocol used to create, manage and terminate sessions in an IP based network. A session could be a simple two-way telephone call or it could be a collaborative multimedia conference session. Generally, SIP is limited to only the setup, modification and termination of sessions. SIP allows for the establishment of user location (i.e., translating from a user's name to their current network address). SIP provides for feature negotiation so that all of the participants in a session can agree on the features to be supported among them. SIP facilitates call management to, for example, add, drop, or transfer participants. SIP allows for changing features of a session while it is in progress.

Entities interacting in a SIP scenario are called User Agents (UA). User Agents may operate in two ways. A User Agent Client (UAC) generates requests and sends those to servers. A User Agent Server (UAS) receives requests, processes those requests and generate responses. The clients 20 shown in FIG. 1 are clients, for example, applications running on the systems used by people, such as a softphone application running computer or a messaging device in an IP phone. A client generates a request when a person places a call another person over the network and sends the request to a server (generally a proxy server).

Servers are in general part of the network, and provide a predefined set of rules to handle the requests sent by clients. Servers can be of several types. A SIP proxy server is the most common type of server in a SIP environment. When a request is generated, the exact address of the recipient is not known in advance. The client sends the request to a proxy server.

The server on behalf of the client (as if giving a proxy for it) forwards the request to another proxy server or the recipient itself. A redirect server redirects the request back to the client indicating that the client needs to try a different route to get to the recipient. A registrar server keeps track of client locations.

A SIP session may be an SIP Invite message sent by a client. An example of a SIP Invite message is as follows.

INVITE sip:user2@server2.com SIP/2.0
Via: SIP/2.0/UDP pc33.server1.com;branch=z9hG4bK776asdhds

### Max-Forwards: 70

To: user2<sip:user2@server2.com>
From: user1 <sip:user1@server1.com>;tag=1928301774
Call-ID: a84b4c76e66710@pc33.server1.com

### CSeq: 314159 INVITE

Contact: <sip:user1@pc33.server1.com>
Content-Type: application/sdp

### Content-Length: 142

The first line of the text-encoded SIP message is called a Request-Line. It identifies that the message is a request. The format of the Requst-Line is Method SP Request-URI SP SIP-Version CRLF [SP=single-space & CRLF=Carriage Return+Line Feed (i.e. the character inserted by the “Enter” or “Return” key). In the above example, the method is INVITE, the request-URI is “user2@server2.com” and SIP version is 2. The following lines are a set of header fields: Via, To, From, Call-ID, etc. The Via header contains the local address of user1, i.e. pc33.server1.com where it is expecting the responses to come. The Max-Forward header is used to limit the number of hops that this request may take before reaching the recipient. The To header contains a display name of the intended recipient of the INVITE message: “user2” and a SIP or SIPS URI <user2@server2.com>. The From header also contains a display name of the sender: “user1” and a SIP or SIPS URI <user1@server1.com>. The From header also contains a tag which is a pseudo-random sequence inserted by the SIP application, to serve as an identifier of the caller in the dialog. The Call-ID header is a globally unique identifier of the call generated as the combination of a pseudo-random string and the softphone's IP address.

The SMLB 100 examines the headers of SIP messages, such as Via, To, From, Call-ID headers to perform its load balancing functions described herein.

The SMLB 100 load balances over one or more connection streams bi-directionally from client-to-server and server-to-client. The purpose of the SMLB 100 is to provide high availability with transparency to the client, load balancing to support scaling of SIP servers, and transport protocol normalization from the prospective of the SIP servers. Clients can use various transport protocols (UDP, TCP, TLS, SCTP-Streaming Control Transport Protocol) but the SIP server only needs to function with one protocol, such as TCP. This eliminates the burden on the SIP server to maintain and support mixed transports while also providing the ability to transparently redirect SIP dialogs to an alternate SIP server in the event that the primary fails (high availability with transparency). Connections to/from the client and servers are maintained independently of each other, thus providing a scalable forwarding plane for SIP messages.

The SMLB 100 is transparent to the client. Therefore, the client merely needs to configure the destination of the SIP server as the SMLB virtual IP (VIP) address. However, the SMLB may load balancing SIP messages over multiple transport socket connections to a client.

The SMLB is not transparent to the SIP server. There are functions that are performed by SIP server in order to interact with the SMLB 100. First, the SIP server instructs all outbound messages to be sent to the SMLB VIP address, no matter what is received in the SIP Request Line, Via, To, From, or Contact headers. Ideally, the SIP server will communicate at Layer 3 and Layer 4 to the SMLB 100 for all SIP messages.

Second, when generating a reply (or request) to SIP messages, the SIP server updates the Via (and To/From/Contact as appropriate) headers to use the correct transport protocol for the client and to use the SMLB VIP address as the “host” instead of the real IP/Fully Qualified Domain Name (FQDN) of the SIP server. This ensures that the client does not become confused when the messages are received by the SMLB IP address instead of the real SIP server IP.

Third, when generating a request, the SIP server will use the SMLB VIP as the IP/host in place of the SIP server IP/host, and specify the correct client address in the SIP request line and To headers and client protocol in the Via. The Via transport protocol from the server to client does not need to match the transport protocol being used between the SMLB 100 and the SIP server. When transmitting the message, the SIP server sends it to the SMLB 100. The SMLB 100 will glean the SIP protocol that should be used towards the client from the Via header and will glean the address to which the SIP message should be sent by looking at Request-Line destination.

Finally, the SIP server maintains its own SIP dialog stateful replication in order for the redundant SIP servers to handle another server's SIP dialog in the event that the primary SIP server fails.

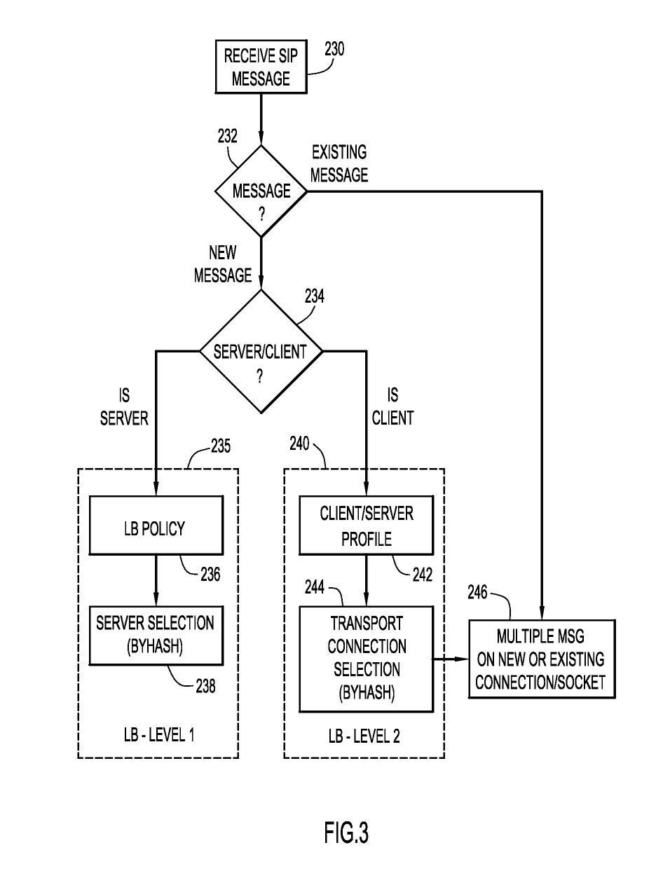

Reference is now made to FIG. 3. FIG. 3 illustrates a flow diagram that generally depicts how the SMLB 100 performs load balancing. There are two levels of load balancing. The first level is based on a load balancing profile, which defines the SIP request type, regular expression (regex) patterns for the message, set of servers, “stickiness” and regex pattern used to identify the content that defines the dialog, as well as the algorithm used for load balancing the messages to the set of servers, such as round robin, etc. The second level of load balancing is optional and involves load balancing messages over multiple transport connections to a server. Stickiness is still maintained to the server itself from the first level. The second level of load balancing enables the ability to distribute load over multiple sockets if desired for buffer queue optimization and lower latency in terms of servicing the socket buffer. As needed, stickiness can be inherited from the first level if configured in the server profile to ensure that SIP messages associated with a call dialog always get load balanced to the same socket connection.

The operational flow of FIG. 3 is as follows. At 230, a SIP message is received. At 232, it is determined whether the received SIP message is a new message or an existing message. If it is a new message, then at 234, it is determined whether the message is a client SIP message or server SIP message. Thus, operation 234 classifies the SIP message as being from a server or from a client. If the SIP message is a server SIP message, then the aforementioned first level of load balancing is performed, shown at reference numeral 235, such that at 236, a specific load balancing policy, stored by the rules engine, is retrieved. At 236, the specific load balancing policy or profile may define one or more of a SIP request type, regular expression patterns for the SIP messages, set of servers, persistence associated with an existing dialog, regular expression pattern to identify content that defines a SIP dialog, and a procedure to use for load balancing SIP messages to the set of servers. Load balancing is based on the specific load balancing profile.

At 238, the server associated with the SIP message is determined by hashing of parameters obtained from the SIP message (but without doing SIP interpretation of the message).

A second level of load balancing is performed at 240, either after the first level of load balancing for server SIP messages or when it is determined at 234 that the SIP message is a client SIP message. At 242, a client or server profile is retrieved. At 244, a transport connection is selected for the SIP message based on the hash of the SIP message parameters referred to above. At 246, the SIP message is then multiplexed on a new or existing connection/socket.

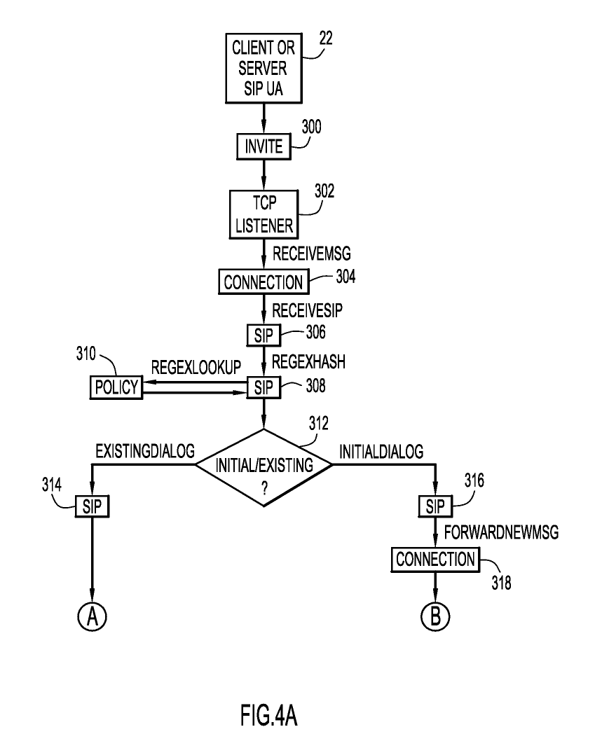

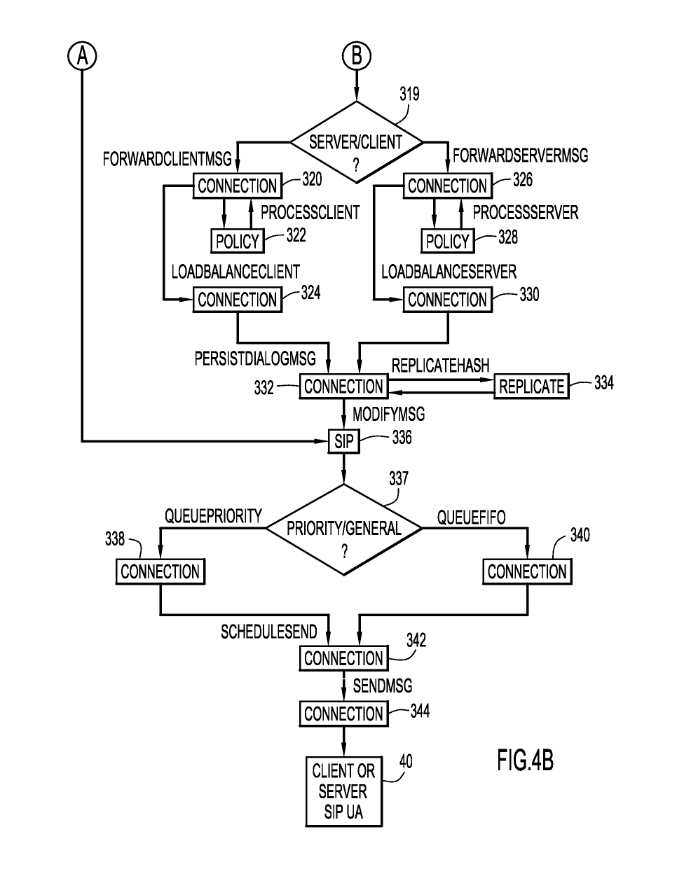

Reference is now made to FIGS. 4A and 4B. These figures, combined, are a flow chart that depicts the message flow from a SIP client or server UA, e.g., client 22, to another SIP client or server UA, e.g., SIP server 40. In the course of describing this flow, the operations of the SMLB 100 are described. In this example, an Invite message is sent at 300 using TCP, for example, and received at the SMLB 100. At 302, the listener and request handler 110 for TCP at the SMLB 100 evaluates the Invite message and classifies it as explained above. At 304, the connection for the received SIP message is persisted, if it is new, so that it can be used for return traffic. At 306, the SIP parameters of the Invite message are extracted. In particular, the Via header parameters are extracted, such as Via: received=<address>, Via: rport=<port>, Via: <ip address:port>, Via: <protocol> and Via: branch=id>, and Call-ID: <id>. At 308 and 310, the SIP/SDP attribute:value and hash are parsed based on attributes matched by user-defined regular expression attributes in order to identify a message flow/dialog. If there is a regular expression match, the SIP/SDP attribute/value regular expression subgroups are added to the MD5 hash. Again, at 308/310, the regex hash is only for the dialog hash.

At 312, it is determined whether the SIP message is for an existing dialog or an initial (new) dialog. If the SIP message is for a new dialog, then at 314, information is stored to indicate this so that a persistent entry exists that always “sticks” a dialog to the same connection. Thus, a SIP message for an existing dialog will be load balanced to the same socket connection as previously used for that dialog. All information needed to forward this message is available, and further processing from this point proceeds as described hereinafter in connection with FIG. 4B. Existing messages interact with the cache, but do not store the initial hash/connection/load balance information. As described hereinafter, at 332, the initial message hash is stored in cache along with the information needed to bi-directionally load balance the dialog.

Operation 318 is the initial entry point for forwarding the SIP message. It is determined whether the connection is from a client or a server. Again, this is an operation of the listener and request handler of the SMLB 100.

While the SMLB 100 does not need to interpret SIP messages, there is one exception. The evaluation towards the client does involve interpreting the Request-Line, “Via”, “To”, and “From” headers to glean a) the transport protocol that should be utilized towards the client (from the Via header), and b) the destination address/FQDN of the client. The To/From headers are used only if configured to be used or if the Request-Line does not provide enough information. Extra content in either of these headers are ignored and passed unaltered. The SMLB 100 strictly looks at the transport protocol and IP/DNS names. The regex patterns for matching can match on specific values, such as branch, etc. Those patterns are user-defined.

Turning to FIG. 4B, at 319, it is determined whether the SIP message is a client message or a server message. the path taken depends on whether the SIP message is a client SIP message or server SIP message. If it is a client SIP message, then at 320 and 322, the rules engine policy dictates how the message is to be load balanced, and at 324 the client SIP message is load balanced over a connection as described above in connection with FIG. 3 for the second level of load balancing for client SIP messages. If the SIP message is a server SIP message, then at 326 and 328, the rules engine policy determines how the message is to be load balanced over multiple servers and connections. At 330, based on the selection in 328, an existing connection will be re-used (multiplexed) or a new connection will be established and cached for future use.

At 332 and 334, dialogs that should persist are saved and replicated, and dialogs that should not persist will not be saved in persist cache nor will they be replicated.

At 336, the SIP message content may be altered, depending on policy. The default policy is not to modify the SIP message, but rules may be configured to change any SIP/SDP header, including changing/updating the Via header to reference a proxy server.

At this point, at 337, it is determined whether to place the message in the priority FIFO 115 or the general FIFO 120 (see FIG. 1) depending in policy. At 338 the message is placed in the priority FIFO and then output via the priority egress queue, or at 340, the message is placed in the general FIFO and then output via the general egress queue. The priority egress queue and general egress queues are processed according to a configurable value of priority messages for every general message, e.g., 5 priority messages sent for every 1 general message. At 342, the message is scheduled to be sent and at 344, it is sent.

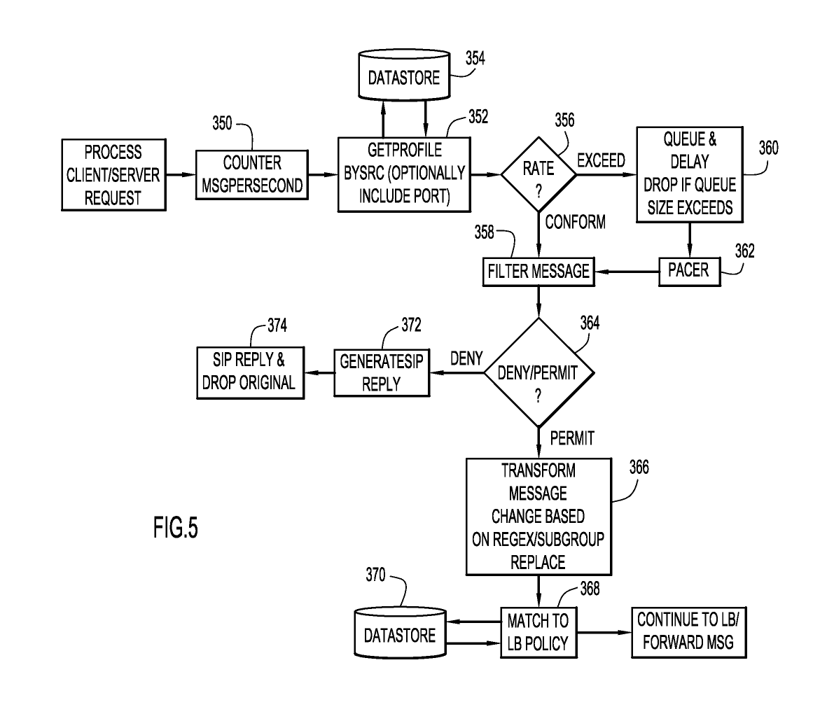

Reference is now made to FIG. 5 for a more detailed description of the operations of the rules engine in processing SIP messages at 332 and 338 in FIG. 4. At 350, a counter is incremented to keep track of the number of messages processed per second. At 352, the profile is retrieved according to source IP address (and optionally port). There are filter rules that operate based on regex name, regex value, permit/deny, SIP response, etc. and may include a chain of matches for a single permit or deny. There are also transformation rules that involve name regex match/replace and value regex match/replace. In addition, there is message rate per second threshold that is retrieved.

At 356, it is determined whether the rate threshold is exceeded. If it is not exceeded, then the message is filtered according to the retrieved filter rules at 358. If the rate threshold is exceeded, then at 360, it is queued and delayed, and dropped if the queue size is exceeded. At 362, the pacer is transmitting packets at the delay value specified in order to ensure SIP messages are transmitted no faster than a specified delay. For example, if the delay is set to 2 milliseconds, then the pacer transmits messages at 2 ms intervals. The queue will grow in size if there are more messages that can be transmitted using the 2 ms interval. When the queue exceeds this configured size, new messages that try to be queued will be dropped. This queuing and rate-limiting is meant to protect both the SMLB 100 and SIP server(s) from message flooding. The delay can be specified in 1/100 of a millisecond value, such as 0.01 milliseconds. Rules to permit/deny traffic can be complex and without rate limiting, could cause an impact to the performance of the SMLB 100. At 364, depending on the filtering results, it is determined whether a deny or permit occurred. If a permit occurred, then at 366, the message is transformed based on regex subgroup/replace policy. At 368 and 370, it is matched to a load balancing policy. In particular, the best matching load balancing policy is found to be used for the message, which determines the connection to be used to forward the message. The global regex hash is used to uniquely identify this message to this connection for future requests. The load balancing policies in the data store 370 may include one or more of:

SIP request line regular expression

SIP header name and value regulator expression

Source IP address prefix list (prefix bits matching: >, >=, <, <=, =)

Source Port address list (port range matching possible)

Sticky (true/false)—indicating if the message persists (based on global regex hash)

Server Pool—association to server pool that defines the servers and number of connections to use as well as the load balancing algorithm. If this is a client connection, then the pool always consists of one, but defines the number of connections to use towards the client. Protocol is defined if this is towards a server. If towards a client, the SIP via transport protocol is used and/or the protocol used by the client when making the initial connection.

After operations 368 and 370, further processing continues at 324 or 330, depending on whether it is a client SIP message or server SIP message.

Thus, operations 368 and 370 serve to evaluate the SIP messages based on regular expression matching. The evaluating may involve matching incoming and outgoing SIP messages to a specific regular expression pattern, and then to multiplex the SIP messages to a transport flow. The “matching” may involve one or more operators including equal to, greater than, greater than or equal to, less than, less than or equal to. Similarly, the evaluating may involve matching one or both of: a SIP request line, SIP header name and value, to a specific regular expression.

When it is determined that the filtering resulted in a deny, then at 372, a SIP response is generated (by the SIP response block 145 of the SMLB 100). At 374, the SIP response is sent, and the original SIP message is dropped.

As depicted in FIG. 5, persistence and load balance selection criteria is accomplished by SIP method and a series of configurable regular expression pattern matching strings. The SIP method and matching regular expression subgroups are hashed to ensure that subsequent messages are forwarded/multiplexed using the same connections.

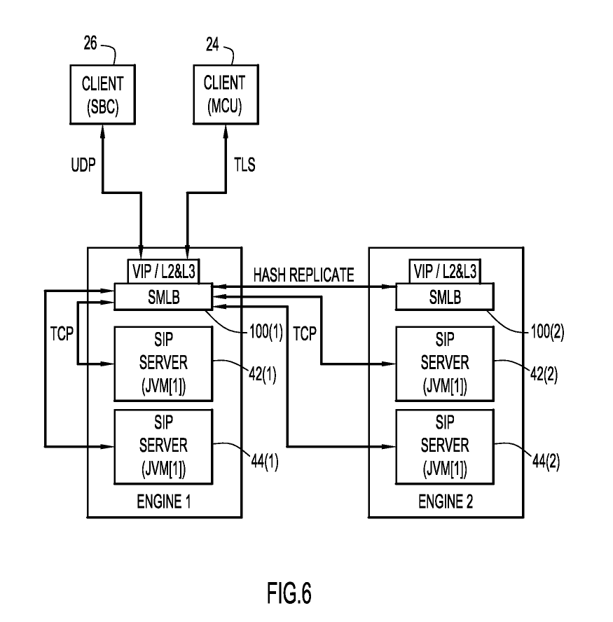

Reference is now made to FIG. 6. In FIG. 6, there are two SMLBs shown at 100(1) and 100(2) in a redundant configuration with hash replication there between. There are SIP servers 42(1) and 44(1), and their redundant counterparts 42(2) and 42(2). The SIP servers are Java virtual machines (JVMs) in this example. Also, in the example of FIG. 6, there are clients 24 and 26, where client 24 is a multipoint switch or multipoint control unit (MCU) and client 26 is an SBC. Client 24 uses the TLS as the transport protocol and client 26 uses UDP as the transport protocol. The SMLB 100(1) maintains the connection for each client independently using the client configured transport protocol.

The SMLB maintains multiplexed sessions to each SIP server instance. Depending on configuration, one or more connections may be used. Note that in this example, TCP is used for connections from the SMLB to each of the SIP servers.

The SMLB acts as a single interface load balancer in that it can run within a SIP server, in parallel to the SIP server, or multiple Layer-3 hops away from the SIP server. High availability is achieved by replicating the load balancing cache and server selection between one or more additional redundant SMLBs. TCP/TLS connections are not replicated, but the SMLB will FIN/ACK close old connections during failover instead of sending a TCP RST.

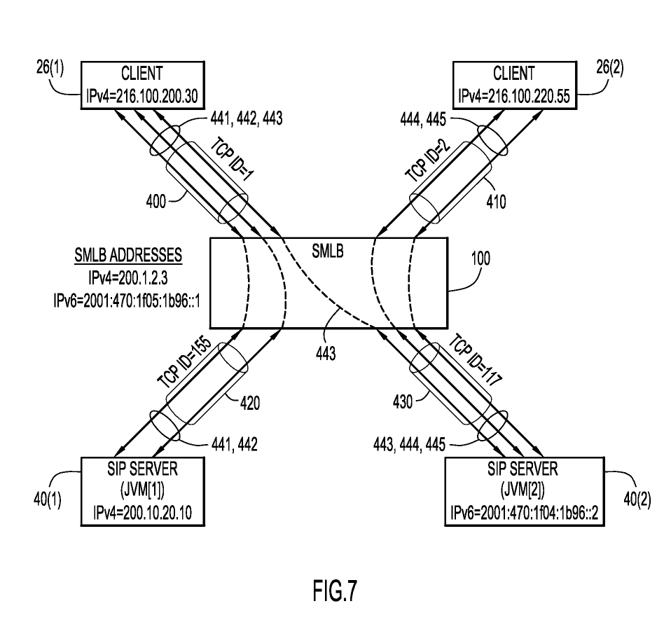

Reference is now made to FIG. 7 for a more detailed description of how the SMLB multiplexes flows. In this example, there are two SBC clients 26(1) and 26(2) and two JVM SIP servers 40(1) and 40(2). The clients 26(1) and 26(2) use IPv4 addresses, SIP server 40(1) uses an IPv4 address, but SIP server 40(2) uses an IPv6 address. Thus, this example shows that the IP version used on the client connections need not be the same as that used for the server connections. The SMLB 100 has an IPv4 address and an IPv6 address.

The connection for TCP ID=1 has the following parameters:

Protocol: TCP

Source IP: 216.100.200.30

Source Port: 5060

Destination IP: 200.1.2.3

Destination Port: 18960

The connection TCP ID=2 has the following parameters:

Protocol: TCP

Source IP: 200.1.2.3

Source Port: 5060

Destination IP: 216.100.220.55

Destination Port: 49381

The connection TCP ID=155 has the following parameters:

Protocol: TCP

Source IP: 200.1.2.3

Source Port: 5060

Destination IP: 200.10.20.10

Destination Port: 20500

The connection TCP ID=117 has the following parameters:

Protocol: TCP

Source IP: 2001:470:1f05:1b96::1

Source Port: 5060

Destination IP: 2001:470:1f04:1b96::2

Destination Port: 32125

In the example of FIG. 7, the SMLB 100 is multiplexing flows for 5 SIP calls. Reference numerals 400, 410, 420 and 430 represent four distinct streams or connections. Stream 400 is to/from client 26(1), stream 410 is to/from client 26(2), stream 420 is to/from SIP server 40(1) and stream 430 is to/from SIP server 40(2). There are three calls 441, 442 and 443 in stream 400 to/from client 26(1) and two calls 444 and 445 in stream 410 to/from client 26(2). The SMLB 100 load balances these calls such that calls 441 and 442 are load balanced to stream 420 to SIP server 40(1) and calls 443, 444, and 445 are load balanced to stream 430 to SIP server 40(2). Call 443 is load balanced to SIP server 40(2) even though calls 441 and 442 for client 26(1) are load balanced to SIP server 40(1).

Thus, in the example of FIG. 7, SIP messages are load balanced over multiple transport socket connections to a server. Again, the SMLB can load balance the calls independent of the transport protocols used by the clients and the servers. Servers can be communicating via IPv4 while clients are using transports via IPv4 and/or IPv6. If a client is using IPv6 and the server is using IPv4, then the client will be sending SIPv6 instead of SIPv4. The SIP server can communicate to the client over the IPv4 transport to the SMLB, but the server does need to communicate using SIPv6. In other words, the SIP server still implements SIPv4 and SIPv6, but it need only to communicate over the network via IPv4 even though clients are using IPv4 and IPv6 to communicate to the SMLB.

Moreover, as explained above, the SIP servers are configured to forward the SIP messages to one of the IP addresses of the SMLB 100 (at Layer 4) regardless of the destination IP address of the SIP message itself. The SMLB 100 handles directing the SIP message from the server back to the particular client that is intended to be sent to. The physical location of the SMLB 100 is extremely flexible. It can reside next to a SIP server or remotely in a data center, etc.

FIG. 7 also shows that the clients and servers may use IPv4 or IPv6 only, and that the IP version need not be the same on the client and server sides of the SMLB 100. This is because the SMLB normalizes the SIP message communications at Layer 3 and Layer 4. Thus, the SMLB 100 has flexibility and allows for a bridge between systems that use exclusively one IP version to systems that use other IP versions.

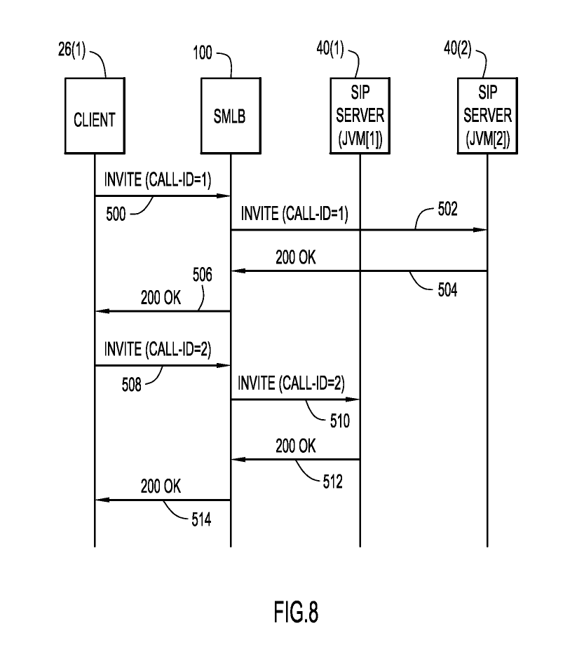

Turning now to FIG. 8, a more detailed call flow example is described for a call initiated by an SBC client 26(1). At 500, client 26(1) sends an Invite message (with Call-ID=1). The SMLB 100 receives this message (unknown and transparent to the client) and at 504 load balances it to SIP server 40(2). The 200 OK SIP message from the SIP server 40(2) is sent to the SMLB 100 at 506, and the SMLB 100 load balances it back to the client 26(1) at 508.

At 508, the client 26(1) sends another Invite message (with Call-ID=2). The SMLB 100 receives this message and at 510 load balances it to SIP server 40(1). SIP server 40(1) sends the 200 OK SIP message to the SMLB 100 at 512, and the SMLB load balances it back to the client 26(1) at 514.

As should be apparent from the foregoing description, the SMLB 100 takes advantage of the contact addressing within the SIP message. The SMLB 100 does not modify or change any SIP/SDP content, which enables the SMLB to support any SIP header and any SDP payload, including S/MIME. The SMLB 100 acts as a SIP multiplexer in that it takes the UDP/TCP/TLS (or other) payload from the client connection and multiplexes it to one or more TCP/TLS (or other) server connections. The reverse is also achieved from server to client.

Both client and server connections are made to one or more VIP/alias addresses (IPv4/IPv6) of the SMLB. The SMLB checks the source address of the connection and determines if the connection is from a server or a client. As explained above in connection with FIGS. 4A and 4B, if the connection is from a client, the payload is load balanced to one of the server connections. If the connection is from a configured server, the payload is multiplexed to an existing or new connection to the client based on the SIP URI.

Reference is now made to FIG. 9, which shows an example hardware block diagram of the SMLB 100. The SMLB 100 may be in the form of a network device that includes one or more network interface cards 600, one or more processors 610, and a memory 620. The network interface card(s) 600 enable network communications for the SMLB 100, and may also be implemented by one or more virtual network interface cards. The memory 620 stores instructions that are executed by the processor 610 and also data used in connection with the operations of the SMLB 100. To this end, the memory 620 stores instructions for SMLB control process logic 630 that, when executed by the processor 610, cause the processor to perform the operations of the SMLB 100 described above in connection with FIGS. 1-8.

The memory 620 may comprise read only memory (ROM), random access memory (RAM), magnetic disk storage media devices, optical storage media devices, flash memory devices, electrical, optical, or other physical/tangible memory storage devices. The processor 610 is, for example, a microprocessor or microcontroller that executes instructions for the SMBL control process logic 630. Thus, in general, the memory 620 may comprise one or more tangible (non-transitory) computer readable storage media (e.g., a memory device) encoded with software comprising computer executable instructions and when the software is executed (by the processor 610) it is operable to perform the operations described herein.

In summary, the SMLB 100 is a highly available SIP transport level multiplexer that load balances both incoming and outgoing SIP dialogs based on regular expression matching (including multiple subgroup matching) and multiplexes the SIP messages to any of a variety of transport protocol flows, such as UDP, TCP, and TLS. Prioritization of SIP dialogs are categorized and queued to ensure proper forwarding of messages symmetrically between real servers and clients. Multiple transports, including IPv4 and IPv6 connections can be inter-mixed between clients and servers. Thus, a server may use one transport protocol while the client connection uses another. Transport protocol type is gleaned from the SIP header/URI. As shown in various examples herein, UDP can be used between the servers while TLS s used from the clients to the servers.

There are numerous advantages associated with the SMLB 100 over current SIP load balancers. Transport and application layers are maintained separately, providing true SIP application load balancing over few or many transport connections. Multiple transport connections will be placed into a connection pool for load balancing, allowing the server or client to use connection based load balancing (if required).

Moreover, multiple queues are provided for prioritizing calls: one priority and one best effort FIFO queue per server connection/pool. Hash mapping is based on simple and extended regular expressions instead of hashing specific fields, such as Call-ID's by themselves. SMLB peering replication of the regular expression matches to SIP hash and assigned server connection.

The load balancing algorithm supports traditional weighted and non-weighted round robin, least connections, application response times, and customizable health states.

The rules engine of the SMLB may be configured to support security protection, rate limiting, Denial of Service (DoS) detection, and conditional based responses for SIP URI's (such as 183, 404, 503). The conditional based responses are user-defined with variable substitution to further enforce that the SMLB 100 is not required to manipulate or understand the SIP headers.

Again, the SMLB operates at the network and transport layer utilizing one or more IP addresses (IPv4 and IPv6) as a proxy for both incoming and outgoing connections, without the requirement to alter or change any SIP header, such as contacts/URI's. TCP and TLS transport level failures can be gracefully shutdown using FIN/ACK close instead of a hard RESET during failover between SMLBs. Further, the SMLB acts as a true proxy for the server(s) incoming and outgoing messages by not requiring to be positioned as the Layer 3 gateway or inline between VLANS for the servers.

The above description is intended by way of example only.

What is claimed is:

1. A method comprising:
at a network device, receiving session initiation protocol (SIP) messages from clients and servers;
evaluating the SIP messages based on regular expression matching; and
load balancing the SIP messages to one or more of a plurality of transport flows based on the evaluating.

2. The method of claim 1, wherein receiving comprises receiving the SIP messages according to any one or more of a plurality of transport protocols.

3. The method of claim 1, wherein evaluating comprises matching incoming and outgoing SIP messages to a specific regular expression pattern, and further comprising multiplexing the SIP messages to a transport flow.

4. The method of claim 1, wherein evaluating comprises matching one or both of: a SIP request line, SIP header name and value, to a specific regular expression.

5. The method of claim 4, wherein evaluating comprises performing regular expression matching to identify a SIP message as being a dialog, and performing regular expression matching to determine how to load balance a SIP message, and further comprising storing a hash of a dialog regular expression so that subsequent messages for a dialog follow the same path bi-directionally.

6. The method of claim 5, wherein evaluating comprises classifying the SIP messages as being from a server or from a client.

7. The method of claim 5, further comprising retrieving from a database a specific load balancing profile which defines one or more of: a SIP request type, regular expression patterns for the SIP messages, set of servers, persistence associated with an existing dialog, regular expression pattern to identify content that defines a SIP dialog, and a procedure to use for load balancing SIP messages to the set of servers, wherein load balancing is based on the specific load balancing profile.

8. The method of claim 5, wherein load balancing comprises load balancing SIP messages over multiple transport socket connections to a server.

9. The method of claim 8, wherein load balancing comprises directing SIP messages for a call dialog over the same socket connection.

10. The method of claim 7, wherein load balancing comprises placing the SIP messages sent back to the servers into one of multiple queues according to SIP message type, each queue having a different prioritization for output.

11. The method of claim 10, further comprising defining a first queue allocated for priority processing and a second queue allocated for best effort processing, and wherein placing comprises placing the SIP messages in either the first queue or the second queue depending on SIP message type.

12. The method of claim 5, wherein load balancing comprises load balancing SIP messages over multiple transport socket connections to a client.

13. The method of claim 1, wherein evaluating is performed without interpreting payload of the SIP messages.

14. The method of claim 1, wherein evaluating comprises evaluating content of one or more of: Request-Line, Via, To and From headers of the SIP messages to determine the transport protocol to be used towards a client, and a destination address of the client.

15. The method of claim 1, wherein receiving comprises receiving SIP messages sent using any of a plurality of transport protocols, and load balancing comprises outputting a SIP message using any of the plurality of transport protocols independent of the transport protocol on which the SIP message is received.

16. The method of claim 1, wherein receiving comprises receiving SIP messages sent using different versions of the Internet Protocol between a client and a server.

17. One or more computer readable storage media encoded with software comprising computer executable instructions and when the software is executed operable to:
receive session initiation protocol (SIP) messages from clients and servers;
evaluate the SIP messages based on regular expression matching; and
load balance the SIP messages to one or more of a plurality of transport flows based on the evaluating.

18. The computer readable storage media of claim 17, wherein the instructions operable to evaluate comprise instructions operable to match incoming and outgoing SIP messages to a specific regular expression pattern, and further comprising instructions operable to multiplex the SIP messages to a transport flow.

19. The computer readable storage media of claim 17, wherein the instructions operable to evaluate comprise instructions operable to classify the SIP messages as being from a server or a client.

20. The computer readable storage media of claim 19, further comprising instructions operable to retrieve from a database a specific load balancing profile which defines one or more of: a SIP request type, regular expression patterns for the SIP messages, set of servers, persistence associated with an existing dialog, regular expression pattern to identify content that defines a SIP dialog, and a procedure to use for load balancing SIP messages to the set of servers, wherein the instructions operable to load balance are operable to load balance based on the specific load balancing profile.

21. The computer readable storage media of claim 19, wherein the instructions operable to load balance comprise instructions operable to direct SIP messages for a call dialog over the same socket connection.

22. The computer readable storage media of claim 19, further comprising instructions operable to place the SIP messages sent back to the servers into one of multiple queues according to SIP message type, each queue having a different prioritization for output.

23. The computer readable storage media of claim 17, wherein the instructions operable to evaluate comprise instructions operable to perform regular expression matching to identify a SIP message as being a dialog, and to perform regular expression matching to determine how to load balance a SIP message, and further comprising instructions operable to store a hash of a dialog regular expression so that subsequent messages for a dialog follow the same path bi-directionally.

24. An apparatus comprising:
a network interface unit configured to enable communications over a network;
a memory;
a processor coupled to the network interface unit and the memory, wherein the processor is configured to:
for session initiation protocol (SIP) messages received from clients and servers, evaluate the SIP messages based on regular expression matching; and
load balance the SIP messages to one or more of a plurality of transport flows based on the evaluating.

25. The apparatus of claim 24, wherein the processor is configured to match incoming and outgoing SIP messages to a specific regular expression pattern, and to multiplex the SIP messages to a transport flow.

26. The apparatus of claim 24, wherein the processor is configured to classify SIP messages as being from a server or a client.

27. The apparatus of claim 26, wherein the processor is configured to retrieve from the memory a database a specific load balancing profile which defines one or more of: a SIP request type, regular expression patterns for the SIP messages, set of servers, persistence associated with an existing dialog, regular expression pattern to identify content that defines a SIP dialog, and a procedure to use for load balancing SIP messages to the set of servers, and to load balance based on the specific load balancing profile.

28. The apparatus of claim 26, wherein the processor is configured to place SIP messages being sent back to the servers into one of multiple queues, in the memory, according to SIP message type, each queue having a different prioritization for output.

29. The apparatus of claim 24, wherein the processor is configured to perform regular expression matching to identify a SIP message as being a dialog, and to perform regular expression matching to determine how to load balance a SIP message, and further configured to store a hash of a dialog regular expression so that subsequent messages for a dialog follow the same path bi-directionally
